(19) United States
(12) Patent Application Publication
(10) Pub. No.: US 2005/0139165 A1
(43) Pub. Date: Jun. 30, 2005

(54) Shedding control device for animals

(76) Inventors: Wendy Lynn Behnke, Appleton, WI (US); Elizabeth Ellen Bell, Appleton, WI (US); James Anthony Cotter II, Waupaca, WI (US); Daniel James Heuer, Fremont, WI (US); Bruce Michael Siebers, Kimberly, WI (US)

Correspondence Address: KIMBERLY-CLARK WORLDWIDE, INC., 401 NORTH LAKE STREET, NEENAH, WI, 54956, US

(21) Appl. No.: 10/748,645

(22) Filed: Dec. 29, 2003

(51) Int. Cl. A01K 13/00

(52) U.S. Cl. 119/601

(57) ABSTRACT

An animal shedding control device is provided including a first layer including a first material, wherein the first layer has a first layer perimetric edge, and wherein the first material is hook material having hooks adapted to capture detritus, and a second layer including a second material, wherein the second layer has a second layer perimetric edge, and wherein at least a portion of the second layer perimetric edge is coupled to the first layer perimetric edge such that the first and second layers define a bag-like space that is at least partially enclosed. The first material may be micro-hook material, and the second layer may be a nonwoven, elastomeric, or micro-hook material. The device may be a mitt, a pet bed enclosure, or a grooming tool cover.

### BACKGROUND

This invention pertains to a device for controlling shedding in pets and other animals, and for grooming such pets and other animals.

Owners of pets and other animals usually face the prospect of repeatedly and often cleaning fur, hair, and dander from various surfaces including carpets and furniture. It is typically advantageous to attract such fur, hair, and dander at their source, the animal itself, before they have a chance to be deposited. Various devices exist for collecting fur, hair, and dander shed by animals, including devices that employ adhesive strips to which the fur, hair, and dander may stick, and durable devices such as brushes.

### SUMMARY OF THE INVENTION

There are disadvantages to using such devices. Adhesive-based devices tend to quickly become matted with fur and hair, greatly decreasing their effectiveness. Durable devices need to be cleaned frequently. In addition, some pets prefer to not be groomed by such devices. As a result, shedding is less controlled and hair and fur become deposited throughout the range of the animal.

To solve these problems, a new micro-hook shedding control device is required.

The elements of the shedding control device are generally a first layer that includes hook material, and a shape that allows for ease of use. Such a device allows a consumer to collect pet dander and the like before it is shed by the animal.

The present invention overcomes these problems by providing an animal shedding control device including a first layer including a first material, wherein the first layer has a first layer perimetric edge, and wherein the first material is hook material having hooks adapted to capture detritus, and a second layer including a second material, wherein the second layer has a second layer perimetric edge, and wherein at least a portion of the second layer perimetric edge is coupled to the first layer perimetric edge such that the first and second layers define a bag-like space that is at least partially enclosed.

The first material may be micro-hook material, and the second layer may be a nonwoven, elastomeric, or micro-hook material. The device may be a mitt, a pet bed enclosure, or a grooming tool cover.

The present invention also provides a shedding control device including a bag-like body including an outer surface including micro-hook material; and an interior space, wherein the body is adapted to be turned inside-out to create a second interior space.

The present invention also provides a method for controlling animal shedding, the method including donning a mitt having a first layer including a first material, wherein the first layer has a first layer perimetric edge, and wherein the first material is hook material having hooks adapted to capture detritus; and a second layer including a second material, wherein the second layer has a second layer perimetric edge, and wherein at least a portion of the second layer perimetric edge is coupled to the first layer perimetric edge such that the first and second layers define a bag-like space that is at least partially enclosed; petting an animal having detritus such that detritus is captured in the hooks; and disposing of the mitt.

The present invention also provides a method for controlling animal shedding, the method including placing a device over an animal bed, the device having a first layer including a first material, wherein the first layer has a first layer perimetric edge, and wherein the first material is hook material having hooks adapted to capture detritus; and a second layer including a second material, wherein the second layer has a second layer perimetric edge, and wherein at least a portion of the second layer perimetric edge is coupled to the first layer perimetric edge such that the first and second layers define a bag-like space that is at least partially enclosed; allowing an animal to use the bed such that detritus is captured in the hooks; removing the device from the bed; and disposing of the device.

Other objects and advantages of the present invention will become more apparent to those skilled in the art in view of the following description and the accompanying drawings.

### BRIEF DESCRIPTION OF THE DRAWINGS

FIG. 1 is a perspective view of a shedding control device of the present invention.

FIG. 2 is a schematic view of the device of FIG. 1, including a thumb space.

FIG. 3 is a schematic view of the device of FIG. 1, including a finger loop.

FIG. 4 is a schematic view of the device of FIG. 1, including a finger slit.

FIG. 5 is a schematic view of the device of FIG. 1, including a finger space.

FIG. 6 is a perspective view of the device of FIG. 1, in use as a pet bed enclosure.

FIG. 7 is a perspective view of the device of FIG. 1, in use as a grooming tool cover.

### DETAILED DESCRIPTION OF THE PREFERRED EMBODIMENTS

The invention described herein is a micro-hook shedding control device 10. Such a device 10 allows a consumer to groom and control shedding in a pet or other animal, including a human. For grooming and shedding control, the user needs to capture primarily fur, hair, dander, debris, and loose organic material, collectively referred to herein as detritus.

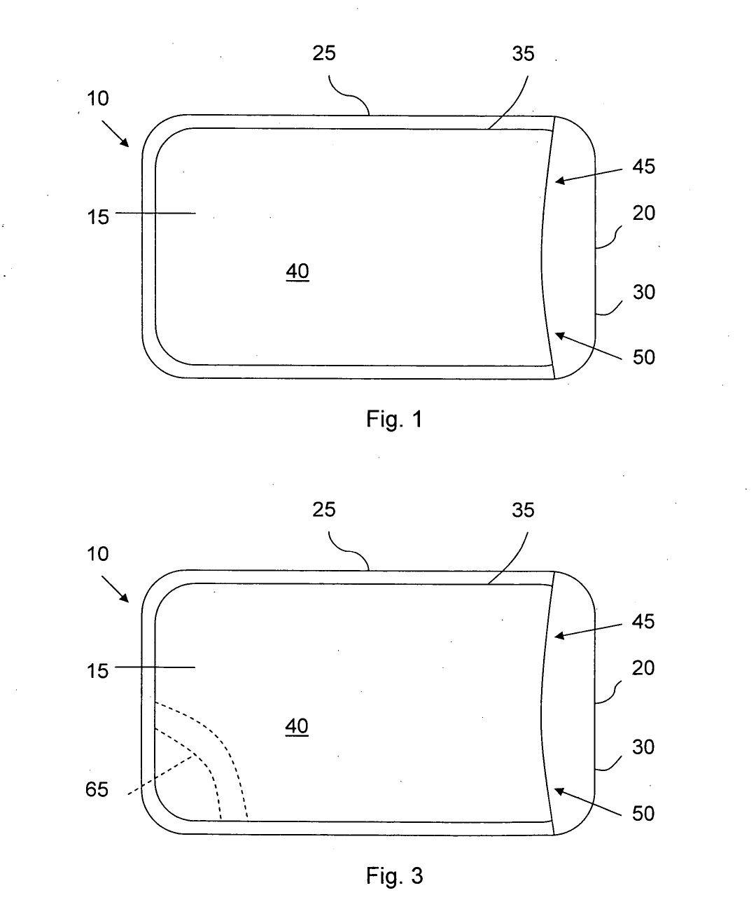

FIG. 1 illustrates an example of a shedding control device 10 of the present invention. The device 10 includes a first layer 15 and a second layer 20. For purposes of illustration, and not for purposes of limitation, the shedding control device 10 is described as a milt. The same device 10, however, may be described as any other suitable form of a shedding control device 10, including an enclosure for a pet bed or a cover for an animal grooming tool. The shedding control device 10 may also be used for the purposes of grooming.

The device 10 includes a first layer 15. The first layer 15 may be of any suitable shape, but is preferably generally planar and is further preferably generally rectangular or oblong. The first layer 15 has a perimetric edge 25 extending around the first layer 15. In one embodiment, the first layer 15 is generally the size of a human hand held flat on a surface. In an alternative embodiment, the first layer 15 is generally the size of a pet or other animal bed. In another alternative embodiment, the first layer 15 is generally the size of a grooming tool. In general, the first layer 15 may be of any suitable size, with the size preferably selected to be suitable for the intended use of the device 10.

The first layer 15 is an active layer. The active layer performs the grooming and shedding-control function, which it accomplishes by including hook material. Hook material includes relatively small and flexible hooks. Hook material is commonly available in hook and loop material such as that manufactured as VELCRO-brand hook and loop fasteners by the American Velcro Company. The hook material is typically formed in a continuous sheet using continuous injection molding, and the hook material typically includes hooks, knobs, or both. Micro-hook material may be used and is considered skin-friendly because the hooks are designed to be relatively small and feel soft to the touch for the average user. The ends of the hooks are typically not exposed at the surface, so the hook material does feel abrasive or sharp. As is known in the art, the manufacturer may tailor the modulus of the hooks by the polymer that is chosen to manufacture them.

Conventional hook and loop fastening systems are, for example, available as VELCRO-brand hook and loop fastening systems. In a particular embodiment, the hook material may be a micro-hook material such as that distributed under the designation CS200 by 3M Company, a business having offices in St. Paul, Minn. Another suitable micro-hook material is distributed under the designation VELCRO CFM-29 1058, and is available from VELCRO U.S.A., Inc., a business having offices in Manchester, N.H.

The hook material may cover all or a portion of the first layer 15. The most inexpensive embodiment may be a first layer 15 consisting essentially of hook material.

In an alternative embodiment, the active layer may also include adhesive to aid in capturing detritus. The adhesive may be applied to the hook material and deposited between and/or at the base of the hooks. The adhesive may be applied by spraying, rolling, or by any other suitable method. The adhesive may be any suitable adhesive; one example is an adhesive that remains tacky after application such as a hot melt resin with a high tackifier level. The hook material itself may be produced with void spaces—areas of hook material that are absent of hooks. Adhesive may then be applied to the void spaces.

In an alternative embodiment, the adhesive may be applied in strips, alternating with strips of hook material. In yet another embodiment, areas of adhesive may be interspersed with areas of hook material in any suitable pattern or dispersion.

The device 10 also includes a second layer 20. The second layer 20 is preferably of the same general size and shape of the first layer 15, although the size and/or shape of the second layer 20 may be selected to be different from the size and/or shape of the first layer 15 based on the intended use of the device 10. The second layer 20 has a perimetric edge 30 extending around the perimeter of the second layer 20.

The second layer 20 may be a backing layer. The second layer 20 may be manufactured from any suitable nonwoven or woven material, including, for example, paper tissue. The second layer 20 may also be manufactured from an elastomeric material to allow for a more snug fit on the user's hand.

In an alternative embodiment, the second layer 20 is also an active layer and manufactured under any of the embodiments described above for the first layer 15. In the case of the second layer 20 as an active layer, the second layer 20 may be manufactured from a different hook material than is used for the first layer 15. For example, the hook material of the second layer 20 my include hooks that are larger than the hooks of the hook material of the first layer 15 to accommodate different grooming needs. In an alternative embodiment, one of the first and second layers 15, 20 may include adhesive where the other does not, or one of the first and second layers 15, 20 may include adhesive where the other includes a different adhesive.

In an alternative embodiment, one or both of the first and second layers 15, 20 may be breathable to allow air to circulate through the device 10.

The first layer 15 is coupled to the second layer 20. One of the first and second layers 15, 20 is positioned to overlie the other of the first and second layers 15, 20, such that the perimetric edges 25, 30 of the first and second layers 15, 20 generally align. A portion of the perimetric edge 25 of the first layer 15 is attached to the perimetric edge 30 of the second layer 20 to form a seam 35. The seam 35 formed may be at the perimetric edges 25, 30, or the seam 35 may be adjacent or inward from the perimetric edges 25, 30. The perimetric edges 25, 30 may be attached by adhesive, ultrasonic bonding, heating, sewing, or by any other suitable method.

Coupling the first layer 15 to the second layer 20 forms the device 10 with a bag-like structure having an outer surface 40 and an interior space 45 with an opening 50. The device 10 may be formed such that the interior space 45 is sized to accommodate a human hand, a pet bed, a portion of a grooming tool, or any other suitable item. Because of this bag-like design, the device 10 may be turned inside-out by a user such that the previous interior space 45 becomes the new outer surface, and the previous outer surface 40 becomes and defines the new interior space. In turning the device 10 inside-out, any detritus captured in the hooks or adhesive on the previous outer surface 40 of the device 10 becomes captured within the new interior space of the device 10.

In an alternative embodiment, the interior space 45 may also include hook material and/or adhesive to allow the device 10 to be used for grooming after being turned inside-out.

The device 10 may be manufactured in any dimensions. For example, the device 10 as a mitt may be sized to fit best on a child's hand, an adult hand, or may be of a length to cover much of an adult's hand and arm.

The device 10 may be manufactured without a thumb space 50 or a finger loop 65. In such an embodiment, pressure from a user's fingers on the seam 35 helps to stabilize the device 10 by helping to prevent rotation of the device 10 around the user's hand.

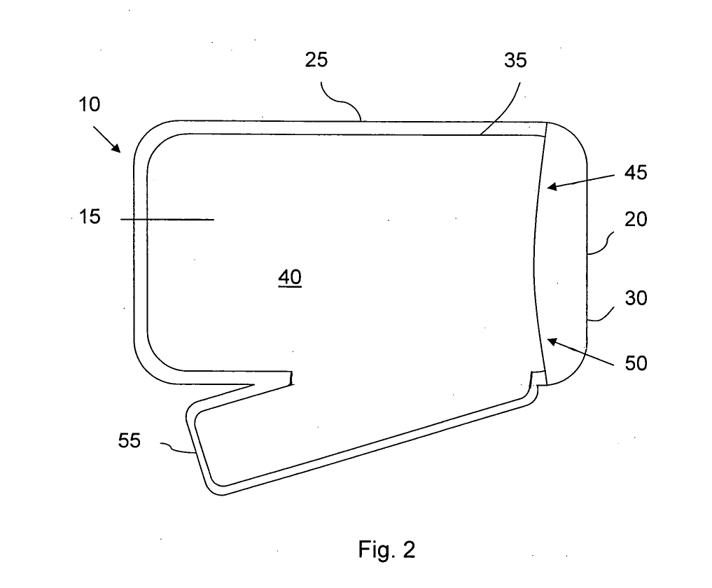

In an alternative embodiment, as illustrated in FIG. 2, the device 10 may include a thumb space 55 sized to accommodate a human thumb. A thumb space 55 helps to stabilize the device 10 in use by helping to prevent rotation of the device 10 around a user's hand. In another alternative embodiment, particularly one on which the second layer 20 is an active layer, the device 10 may also be manufactured with a second thumb space (not shown) on the opposing perimetric edge 25 of the device 10, such that one thumb space 55 may be used when the first layer 15 is used to collect detritus, and the other thumb space (not shown) may be used when the second layer 20 is used to collect detritus.

In still another alternative embodiment, as illustrated in FIG. 3, the device 10 may include a finger loop 65 within the space. With a finger inserted in the finger loop 65 during use, the finger loop 65 helps to stabilize the device 10 by helping to prevent rotation of the device 10 around a user's hand. The finger loop 65 may be formed from any suitable material including the nonwoven described above, and may be formed with either the first or second layers 15, 20, or formed independently of the first and second layers 15, 20. The finger loop 65 may be attached to either of the first or second layers 15, 20, or the finger loop 65 may be attached to the device 10 in conjunction with coupling the first layer 15 to the second layer 20. The finger loop 65 may assist a user in turning the device 10 inside-out by grasping the finger loop 65 and pulling.

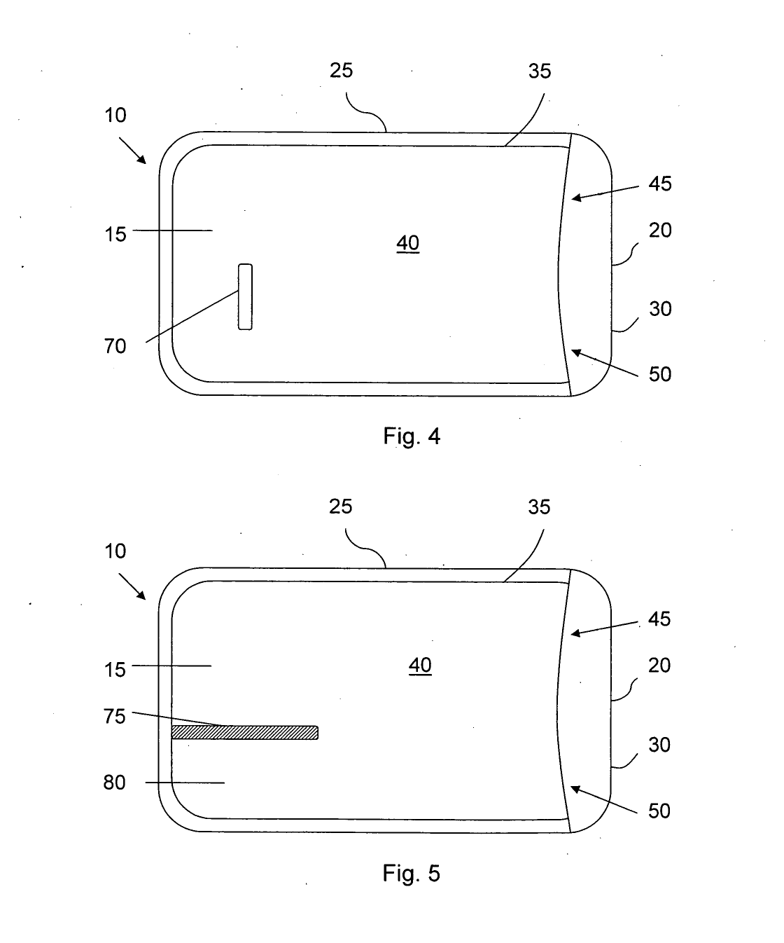

In yet another alternative embodiment, as illustrated in FIG. 4, the device 10 may include a finger slit 70 appropriately positioned in the first layer 15, second layer 20, or both first and second layers 15, 20. With a finger inserted through the finger slit 70 during use, the finger slit 70 helps to stabilize the device 10 by helping to prevent rotation of the device 10 around a user's hand.

In yet another alternative embodiment, as illustrated in FIG. 5, the device 10 may include a line of stitching, glue, or other suitable means 75 to define a finger space 80 within the interior space 45 to help prevent rotation of the device 10 around a user's hand.

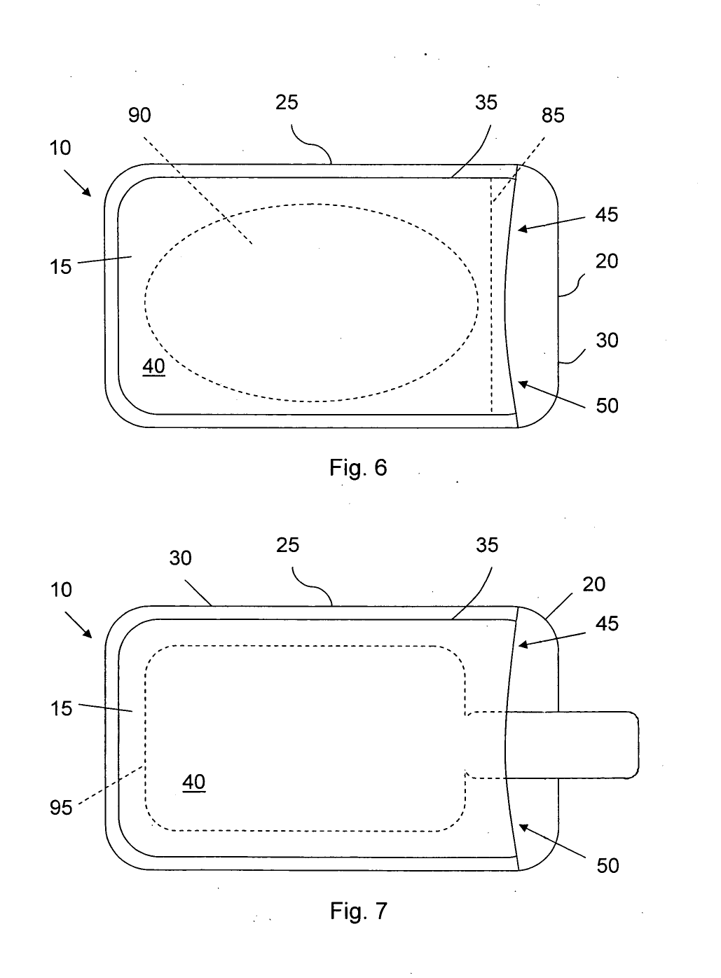

The opening 50 of the device 10 may include a sealing mechanism 85 (see FIG. 6) to allow the opening 50 to be closed. The sealing mechanism 85 may be hook material, adhesive, a zipper-like mechanism, or any other suitable sealing mechanism. In turning the device 10 inside-out and capturing any detritus within the interior space 45 of the device 10, the sealing mechanism 85 can then be used to ensure that the detritus remains within the interior space 45 for disposal without mess.

By virtues of the design and materials chosen for the device 10, the device 10 is preferably designed to be disposable. In this case, disposable means that the device 10 is disposed of, rather than cleaned, after use.

In an alternative embodiment of the device 10, the first layer 15 and the second layer 20 are two portions of the same piece of material. One of the first and second layers 15, 20 is folded over the other of the first and second layers 15, 20 and a portion of their perimetric edges 25, 30 are coupled by any means described herein to form the device 10.

In use of the device 10 as a milt, as illustrated in FIGS. 1-5, when a user recognizes a need for collecting detritus from an animal before the animal sheds the detritus, the user selects and dons the device 10. The user then pets or rubs the animal with the user's hand in the device 10, allowing the hooks and/or adhesive of the first layer 15 to capture detritus. The user then removes the device 10, turning the device 10 inside-out, and capturing the detritus within the inside-out device 10. The user may then seal the device 10 if the device 10 is equipped with a sealing mechanism 85. With or without sealing the device 10, the user then disposes of the device 10 and along with it the detritus removed from the animal.

In use of the device 10 as a pet bed enclosure, as illustrated in FIG. 6, the user may remove detritus from an animal on a consistent basis before the animal can shed the detritus. The user selects an appropriate device 10 and places within it a pet bed, pillow, cushion, or other suitable item 90. The user then allows the animal to rest on the item 90 as the animal normally would. Natural movements of the animal against the device 10 allow the hooks and/or adhesive of the first layer 15 and/or second layer 20 to capture detritus. The user then removes the device 10, turning the device 10 inside-out, and capturing the detritus within the inside-out device 10. The user may then seal the device 10 if the device 10 is equipped with a sealing mechanism 85. With or without sealing the device 10, the user then disposes of the device 10 and along with it the detritus removed from the animal. In this case, the device 10 may also be equipped with a second sealing mechanism (not shown) to allow the device 10 to be sealed during use to enclose the pet bed, pillow, cushion, or other suitable item 90. The user may also use the device 10 as a shedding-control matt by placing the device 10 on a carpet, a piece of furniture, or any other resting place for the animal to perform the same function.

In use of the device 10 as a cover for a grooming tool 95, as illustrated in FIG. 7, when a user recognizes a need for collecting detritus from an animal before the animal sheds the detritus, the user selects an appropriate device 10 and places the device 10 over the grooming tool 95. The user then pets or rubs the animal with the grooming tool 95 in the device 10, allowing the hooks and/or adhesive of the first layer 15 to capture detritus. The user then removes the device 10, turning the device 10 inside-out, and capturing the detritus within the inside-out device 10. The user may then seal the device 10 if the device 10 is equipped with a sealing mechanism. In this case, the device 10 may also be equipped with a second sealing mechanism (not shown) to allow the device 10 to be sealed during use to enclose the grooming tool 95. With or without sealing the device 10, the user then disposes of the device 10 and along with it the detritus removed from the animal.

Other objects and advantages of the present invention will become more apparent to those skilled in the art in view of the following description and the accompanying drawings.

The invention has been described with reference to various specific and illustrative embodiments and techniques. However, it should be understood that many variations and modifications may be made while remaining within the spirit and scope of the invention. Many alternatives, modifications and variations will be apparent to those skilled in the art in light of the foregoing description. Accordingly, this invention is intended to embrace all such alternatives, modifications, and variations that fall within the spirit and scope of the appended claims.

1. An animal shedding control device comprising:
a first layer including a first material, wherein the first layer has a first layer perimetric edge, and wherein the first material is hook material having hooks adapted to capture detritus;
a second layer including a second material, wherein the second layer has a second layer perimetric edge, and wherein at least a portion of the second layer perimetric edge is coupled to the first layer perimetric edge such that the first and second layers define a bag-like space that is at least partially enclosed, wherein the bag-like space includes an open end; and
a sealing mechanism positioned adjacent the open end.

2. The device of claim 1, wherein the first material is microhook material.

3. The device of claim 1, wherein the second material is a nonwoven material.

4. The device of claim 1, wherein the second material is an elastomeric material.

5. The device of claim 1, wherein the second material is microhook material.

6. The device of claim 1, wherein the device is a mitt.

7. The device of claim 1, wherein the device is a pet bed enclosure.

8. The device of claim 1, wherein the device is a grooming tool cover.

9. The device of claim 1, wherein the first layer is coupled to the second layer using adhesive.

10. The device of claim 1, wherein the first layer is coupled to the second layer using ultrasonic bonding.

11. The device of claim 1, wherein the first layer is coupled to the second layer by sewing.

12. The device of claim 1, further comprising a thumb space.

13. The device of claim 1, further comprising a finger loop within the space.

14. The device of claim 1, wherein the first layer further includes adhesive.

15. The device of claim 14, wherein the adhesive is positioned on the hook material.

16. (canceled)

17. The device of claim 1, wherein the sealing mechanism uses hook material.

18. The device of claim 1, wherein the sealing mechanism is a zipper-like device.

19. The device of claim 1, wherein the sealing mechanism is an adhesive.

20. The device of claim 1, wherein the device is disposable.

21. The device of claim 1, wherein the first and second materials are one piece of the same material, wherein the first layer and the second layer are two portions of the piece, and wherein one of the first and second layer is folded over the other of the first and second layer.

22. The device of claim 1, wherein the space is sized to substantially enclose a human hand.

23. The device of claim 1, wherein the space is sized to enclose a pet bed.

24. The device of claim 1, wherein the space is sized to enclose a portion of a grooming tool.

25. The device of claim 1, wherein the first material consists essentially of hook material.

26. A shedding control device comprising:
a bag-like body including
an outer surface including micro-hook material;
an interior space, wherein the body is adapted to be turned inside-out to create a second interior space; and
a sealing mechanism.

27. A method for controlling animal shedding, the method comprising:
donning a mitt having
a first layer including a first material, wherein the first layer has a first layer perimetric edge, and wherein the first material is hook material having hooks adapted to capture detritus,
a second layer including a second material, wherein the second layer has a second layer perimetric edge, and wherein at least a portion of the second layer perimetric edge is coupled to the first layer perimetric edge such that the first and second layers define a bag-like space that is at least partially enclosed, wherein the bag-like space includes, an open end, and
a sealing mechanism positioned adjacent the open end;
petting an animal having detritus such that detritus is captured in the hooks; and
disposing of the mitt

28. The method of claim 27, further comprising turning the mitt inside-out to enclose the detritus.

29. The method of claim 27, further comprising sealing the mitt.

30. A method for controlling animal shedding, the method comprising:
enclosing an animal bed with a device having
a first layer including a first material, wherein the first layer has a first layer perimetric edge, and wherein the first material is hook material having hooks adapted to capture detritus,
a second layer including a second material, wherein the second layer has a second layer perimetric edge, and wherein at least a portion of the second layer perimetric edge is coupled to the first layer perimetric edge such that the first and second layers define a bag-like space that is at least partially enclosed, wherein the bag-like space include an open end, and
a sealing mechanism positioned adjacent the open end;
allowing an animal to use the bed such that detritus is captured in the hooks;
removing the device from the bed; and
disposing of the device.

31. The method of claim 30, further comprising turning the device inside-out to enclose the detritus.

32. The method of claim 30, further comprising sealing the device.

33. (canceled)

34. (canceled)

35. The device of claim 1, further comprising a finger slit.

36. The method of claim 27, wherein the donning act includes extending a finger through a finger slit.
